(19) United States
(12) Patent Application Publication
(10) Pub. No.: US 2006/0177228 A1
(43) Pub. Date: Aug. 10, 2006

(54) Impedance matching broadband optical receiver circuit

(76) Inventor: Howard Loboda, Jerusalem (IL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/054,482

(22) Filed: Feb. 9, 2005

(51) Int. Cl. H04B 10/06

(52) U.S. Cl. 398/202

(57) ABSTRACT

An impedance matching broadband optical receiver circuit including an input terminal adapted to receive an input information bearing signal, extending over a broad input frequency band, and a plurality of output terminals operative to provide, in response to receipt of the input information bearing signal, respective outputs in generally non-overlapping frequency bands, plural ones of the outputs presenting different characteristic impedances to the input.

### FIELD OF THE INVENTION

The present invention relates to broadband optical receivers generally and more particularly to impedance matching circuitry useful in broadband optical receivers.

### BACKGROUND OF THE INVENTION

The following U.S. patents are believed to represent the current state of the art:

U.S. Pat. Nos. 5,179,461; 5,477,370; 5,347,388; 5,517,035; 5,013,903; 5,095,286 and 5,845,302.

### SUMMARY OF THE INVENTION

The present invention seeks to provide an improved impedance matching broadband optical receiver circuit.

There is thus provided in accordance with a preferred embodiment of the present invention an impedance matching broadband optical receiver circuit including an input terminal adapted to receive an input information bearing signal, extending over a broad input frequency band, and a plurality of output terminals operative to provide, in response to receipt of the input information bearing signal, respective outputs in generally non-overlapping frequency bands, plural ones of the outputs presenting different characteristic impedances to the input.

Preferably, the outputs in generally non-overlapping frequency bands are substantially non-overlapping at their peak input impedances.

Preferably, the impedance matching broadband optical receiver circuit also includes a photodiode having an output which is coupled to the input terminal. Additionally or alternatively, the impedance matching broadband optical receiver circuit also includes a multiplexer combining the respective outputs.

Preferably, the respective outputs include a CATV (50-862 MHz) output.

Preferably, the impedance matching broadband optical receiver circuit also includes a high-pass network coupled to the input terminal. Preferably, the impedance matching broadband optical receiver circuit also includes at least one band-pass network coupled to the input terminal. Preferably, the impedance matching broadband optical receiver circuit also includes a low-pass network coupled to the input terminal.

### BRIEF DESCRIPTION OF THE DRAWINGS

The present invention will be understood and appreciated more fully from the following detailed description, taken in conjunction with the drawings in which:

FIG. 1 is a simplified block diagram illustration of an impedance matching broadband optical receiver circuit constructed and operative in accordance with a preferred embodiment of the present invention;

FIG. 2 is a simplified diagram illustrating the frequency distribution of each of a plurality of different impedances provided by the circuitry of FIG. 1;

FIGS. 3A and 3B are simplified partially block diagram illustrations of two alternative embodiments of the circuitry of FIG. 1; and

FIG. 4 is a partially block diagram, partially schematic illustration of a preferred embodiment of the circuitry of FIG. 1.

### DETAILED DESCRIPTION OF PREFERRED EMBODIMENTS

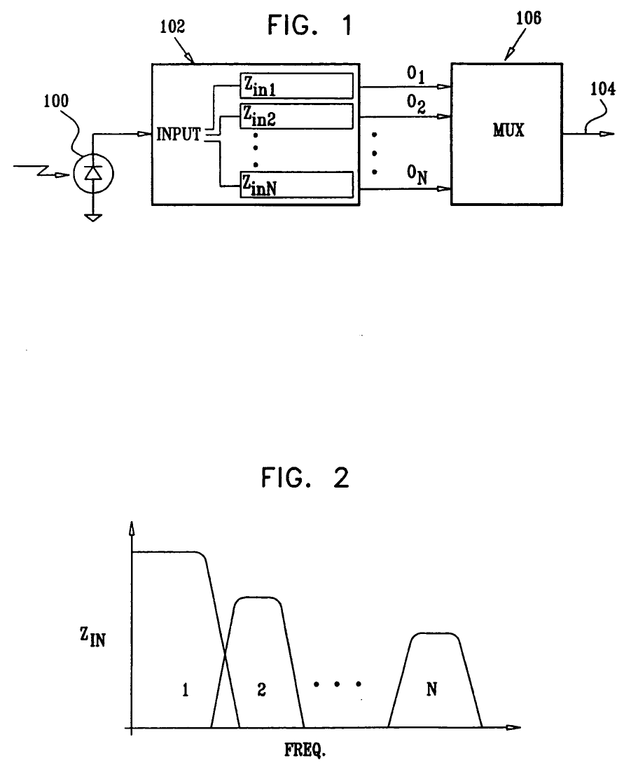

Reference is now made to FIGS. 1 and 2, which show an impedance matching broadband optical receiver circuit constructed and operative in accordance with a preferred embodiment of the present invention and a preferred frequency distribution of each of a plurality of different impedances provided by the circuitry of FIG. 1. As seen in FIG. 1, a broadband input, preferably from a photodiode 100, is received by the circuitry of the present invention, designated by reference numeral 102, which provides a plurality of outputs O₁ . . . O_{N}, each of which presents a different characteristic impedance to the input, the different impedances being designated as Zᵢₙ₁ . . . Z_{inN}.

In accordance with a preferred embodiment of the present invention, the plurality of outputs O₁ . . . O_{N} may be combined into a single output, preferably on a coaxial cable 104, by a conventional multiplexer 106.

FIG. 2 illustrates a preferred frequency distribution of the outputs O₁ . . . O_{N}, wherein it is seen that although the frequency curves partially overlap, the frequencies of the various outputs O₁ . . . O_{N} are distinct and non-overlapping at their respective peak input impedances.

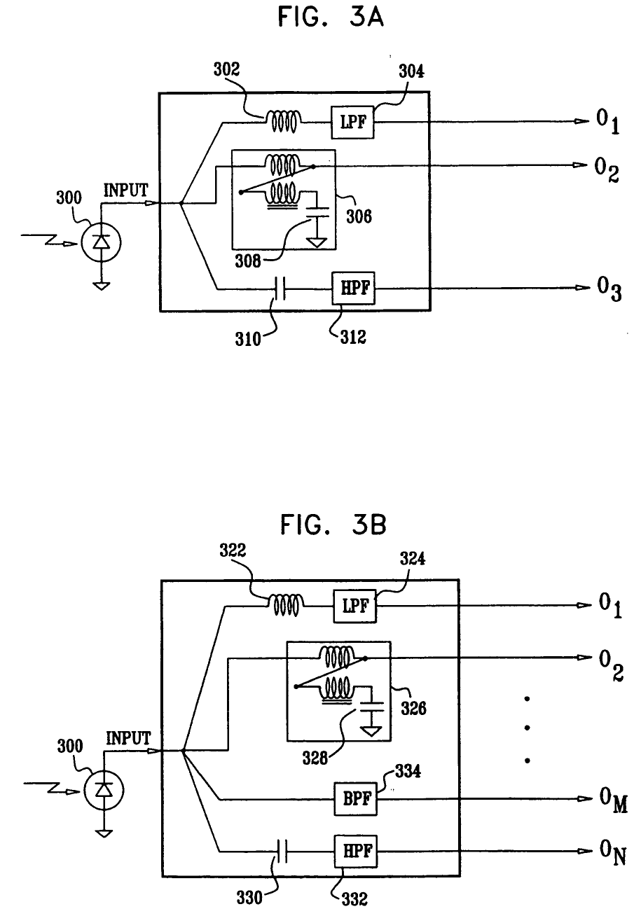

Reference is now made to FIGS. 3A and 3B, which are simplified partially block diagram illustrations of two alternative embodiments of the circuitry 102 of FIG. 1. In the embodiment of FIG. 3A, the output of a photodiode 300 is fed in parallel to a series combination of an inductor 302 and a low-pass filter 304, providing a first output O₁; to at least one broadband transformer 306 including a capacitive filter 308, providing at least one additional output O₂; and to a series combination of a capacitor 310 and a high-pass filter 312, providing at least one additional output O₃.

In the embodiment of FIG. 3B, the output of photodiode 300 is fed in parallel to a series combination of an inductor 322 and a low-pass filter 324, providing a first output O₁; to at least one broadband transformer 326 including a capacitive filter 328, providing at least one additional output O₂; preferably to a series combination of a capacitor 330 and a high-pass filter 332, providing an additional output O_{N} and to at least one band-pass filter 334 providing at least one additional output O_{M}. It is appreciated that by providing multiple band-pass filters defining different pass bands, in parallel to band-pass filter 334, multiple outputs each having a different input impedance may be provided.

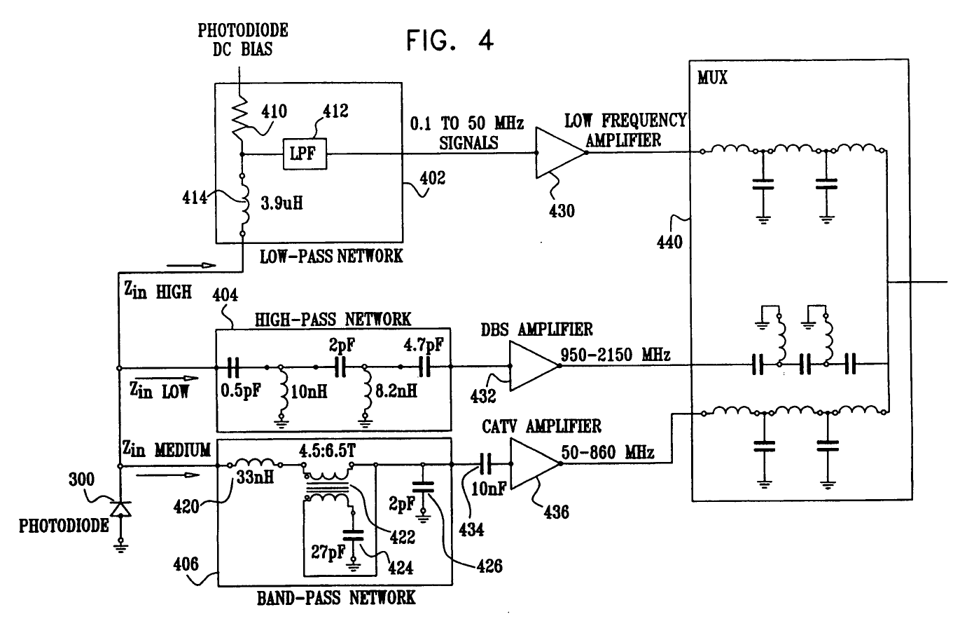

Reference is now made to FIG. 4, which is a partially block diagram, partially schematic, illustration of a preferred embodiment of the circuitry of FIG. 1. As seen in FIG. 4, the output of photodiode 300 is coupled in parallel to a low-pass network 402, a high-pass network 404 and a band-pass network 406.

The low-pass network 402 preferably is DC biased via a resistor 410 and outputs a signal of frequency preferably between 0.1 and 50 MHz preferably via a low-pass filter 412 connected at a junction of resistor 410 and an inductor 414. The low-pass network 402 is operative to present a relatively high impedance, typically at least 2000 Ohms, to photodiode 300.

The high-pass network 404 preferably includes a capacitor and inductor network which presents a relatively low impedance, typically below 100 Ohms, to photodiode 300.

The band-pass network 406, of which there may be multiple such networks having different pass bands, preferably includes a series inductor 420 connected to a broadband transformer 422, including a capacitive filter 424, and a band shaping grounded capacitor 426. Band-pass network 406 presents an intermediate impedance, typically between 200 and 1000 Ohms, to photodiode 300.

The low-pass network 402 preferably outputs to a low frequency amplifier 430, which provides an output in the 0.1-50 MHz frequency range.

The high-pass network 404 preferably outputs to a DBS amplifier 432 which provides an output in the 950-2150 MHz range.

The band-pass network 406 outputs via a DC blocking capacitor 434 to a CATV amplifier 436 which provides an output in the 50-860 MHz range.

The outputs of the low-pass, high-pass and band-pass networks may be, but need not necessarily be, combined by a multiplexer 440 preferably including multiple capacitor and inductor networks.

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to a person of ordinary skill in the art upon reading the foregoing description, and which are not in the prior art.

1. An impedance matching broadband optical receiver circuit comprising:
an input terminal adapted to receive an input information bearing signal, extending over a broad input frequency band; and
a plurality of output terminals operative to provide, in response to receipt of said input information bearing signal, respective outputs in generally non-overlapping frequency bands, plural ones of said outputs presenting different characteristic impedances to said input.

2. An impedance matching broadband optical receiver circuit according to claim 1 and wherein said outputs in generally non-overlapping frequency bands are substantially non-overlapping at their peak input impedances.

3. An impedance matching broadband optical receiver circuit according to claim 1 and also comprising a photodiode having an output which is coupled to said input terminal.

4. An impedance matching broadband optical receiver circuit according to claim 1 and also comprising a multiplexer combining said respective outputs.

5. An impedance matching broadband optical receiver circuit according to claim 3 and also comprising a multiplexer combining said respective outputs.

6. An impedance matching broadband optical receiver circuit according to claim 1 and wherein said respective outputs include a CATV (50-862 MHz) output.

7. An impedance matching broadband optical receiver circuit according to claim 1 and also comprising a high-pass network coupled to said input terminal.

8. An impedance matching broadband optical receiver circuit according to claim 1 and also comprising at least one band-pass network coupled to said input terminal.

9. An impedance matching broadband optical receiver circuit according to claim 1 and also comprising a low-pass network coupled to said input terminal.

10. An impedance matching broadband optical receiver circuit according to claim 3 and wherein said respective outputs include a CATV (50-862 MHz) output.

11. An impedance matching broadband optical receiver circuit according to claim 3 and also comprising a high-pass network coupled to said input terminal.

12. An impedance matching broadband optical receiver circuit according to claim 3 and also comprising at least one band-pass network coupled to said input terminal.

13. An impedance matching broadband optical receiver circuit according to claim 3 and also comprising a low-pass network coupled to said input terminal.

14. An impedance matching broadband optical receiver circuit according to claim 4 and wherein said respective outputs include a CATV (50-862 MHz) output.

15. An impedance matching broadband optical receiver circuit according to claim 4 and also comprising a high-pass network coupled to said input terminal.

16. An impedance matching broadband optical receiver circuit according to claim 4 and also comprising at least one band-pass network coupled to said input terminal.

17. An impedance matching broadband optical receiver circuit according to claim 4 and also comprising a low-pass network coupled to said input terminal.

18. An impedance matching broadband optical receiver circuit according to claim 5 and wherein said respective outputs include a CATV (50-862 MHz) output.

19. An impedance matching broadband optical receiver circuit according to claim 5 and also comprising a high-pass network coupled to said input terminal.

20. An impedance matching broadband optical receiver circuit according to claim 5 and also comprising at least one band-pass network coupled to said input terminal.

21. An impedance matching broadband optical receiver circuit according to claim 5 and also comprising a low-pass network coupled to said input terminal.
